(19) United States
(12) Patent Application Publication
(10) Pub. No.: US 2012/0229391 A1
(43) Pub. Date: Sep. 13, 2012

(54) SYSTEM AND METHODS FOR GENERATING INTERACTIVE DIGITAL BOOKS

(76) Inventors: Andrew Skinner, Hornsby (AU); Rafiq Ahmed, Burr Ridge, IL (US); Christopher Roosen, Sydney (AU); Daniel Hotop, Emu Plains (AU); Muhammed Ishaq, Lahore (PK)

(21) Appl. No.: 13/347,539

(22) Filed: Jan. 10, 2012

Related U.S. Application Data
(60) Provisional application No. 61/431,121, filed on Jan. 10, 2011.

(51) Int. Cl. G06F 3/041

(52) U.S. Cl. 345/173

(57) ABSTRACT

A system and methods for creating interactive digital books utilizing a multi-touch input and display device to allow users or authors to create stories including embedded interactive effects in response to received multi-touch inputs from the reader. The system and method allows book authors to create interactive effects through author gesture inputs through the multi-touch display rather than through traditional coding methods.

### CROSS-REFERENCE TO RELATED APPLICATIONS

This application claims the benefit of U.S. Provisional Application No. 61/431,121 filed Jan. 10, 2011, which is hereby incorporated by reference as though fully set forth herein.

### BACKGROUND OF THE INVENTION

a. Field of the Invention

The present disclosure relates to the creation and publishing of electronic book applications. More specifically, it relates to systems and methods of creating and assembling digital book content and effects to render the content interactive.

b. Background Art

A digital book is a publication of a book-length story in a digital format. A digital book may also be referred to as an electronic book or an e-book, and consists of text, rich images and/or other rich media. The text, images and/or other rich media of the digital book can be read using a general purpose computer, a computer tablet, an e-reader or even a cellular telephone, among other devices.

Interactive books or interactive digital books are a subset of digital books in which the reader can participate or interact with the text and/or images on the digital book. The current state of interactive digital books, and in particular, the creation of these interactive digital books is principally found in existing software platforms that enable users to assemble interactive digital books but require extensive knowledge of computer programming and animation techniques to incorporate animation into the book, thereby making the digital book interactive.

Interactive digital book applications have appeared on a number of mobile and desktop hardware platforms. Currently, creating an interactive book is a complex, time-consuming and programming intensive process. First, content must be imported into a development environment and assembled into an application framework. Then, any desired animation effects must be coded into the application. Finally, the finished product must be exported and published to the various application stores for purchase by end customers. Each step of this process requires extensive software development experience, including extensive knowledge of programming languages and programming techniques, making it difficult for publishers and individual authors and artists to create interactive digital books.

Extensible markup language (“XML”) is a heterogeneous data language designed to transport and store data. XML became a W3C Recommendation on Feb. 10, 1998. A heterogeneous data language such as XML theoretically allows publishers and designers to create their own customized tag elements, enabling the definition, transmission, validation, and interpretation of data between applications.

It would be advantageous, therefore, to provide a system and method allowing an author to create an interactive digital book, including interactive effects, without having computer programming experience. The invention described in this application would obviate the need for expertise in programming or animation, enabling authors to create interactive digital books without having to write or edit any computer code.

### BRIEF SUMMARY OF THE INVENTION

The invention described herein is a system and methods for generating interactive digital books. The main advantage that this system offers over existing approaches to creating interactive digital books is that it does not require familiarity with programming languages or animation techniques. Most authors and illustrators do not possess familiarity with programming languages or animation techniques. Thus, if they wish to create an interactive book, they must hire outside help from programmers and animators, which makes creating an interactive book into a very expensive proposition. The invention described in this application reduces the expense, time and effort of creating an interactive digital book by obviating the need for expertise in programming and animation. The disclosed system an methods refer to interactive digital books, but the disclosed system and methods are equally applicable to other digital media formats in which an author without programming knowledge intends to add interactive effects. These related media formats include digital postcards, advertisements, calendars, presentations and other digital compositions.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic diagram illustrating an exemplary embodiment of a system for generating interactive digital books.

FIG. 2 is a flow chart illustrating an example of the steps to create an interactive digital book.

FIGS. 3A and 3B are tables containing examples of adjustable asset properties that can be used in pages of the interactive digital book.

FIG. 4 depicts a touch point.

FIG. 5 depicts the gesture that a user would execute to accomplish a pinch in effect.

FIG. 6 depicts the gesture that a user would execute to accomplish a pinch out effect.

FIG. 7 depicts the gesture that a user would execute to accomplish a rotate clockwise motion.

FIG. 8 depicts the gesture that a user would execute to accomplish a rotate anti-clockwise motion.

FIG. 9 depicts the gesture that a user would execute to accomplish a drag motion.

FIG. 10 is a table containing examples of triggering gestures or events that can be added with the behavior engine module.

FIGS. 11A to 11D are tables containing examples of events that can be performed after an associated trigger gesture and been received from the multi-touch display input.

### DETAILED DESCRIPTION OF THE INVENTION

It is understood that the description herein is only illustrative of the application of the basic principles of the present invention. Numerous modifications and alternative arrangements may be devised by those skilled in the art without departing from the spirit and scope of the present invention. The proceeding arrangements are intended to cover such modifications and arrangements.

It should be understood that the drawings are not necessarily to scale; instead emphasis has been placed upon illustrating the principles of the invention.

The system of the present invention is described below with reference to flowchart illustrations and block diagrams of methods, apparatus, systems and computer program products according to embodiments of the invention. It will be understood that each block of the flowchart illustrations and block diagrams, and combinations of blocks in the flowchart illustrations and block diagrams, can be implemented by computer program instructions located in a memory and run by a microprocessor. These computer program instructions may be provided to a processor of a general purpose computer, special purpose computer, or other programmable data processing apparatus to produce a machine, such that the instructions, which execute via the processor of the computer or other programmable data processing apparatus, implement the functions or acts specific in the flowcharts and block diagrams.

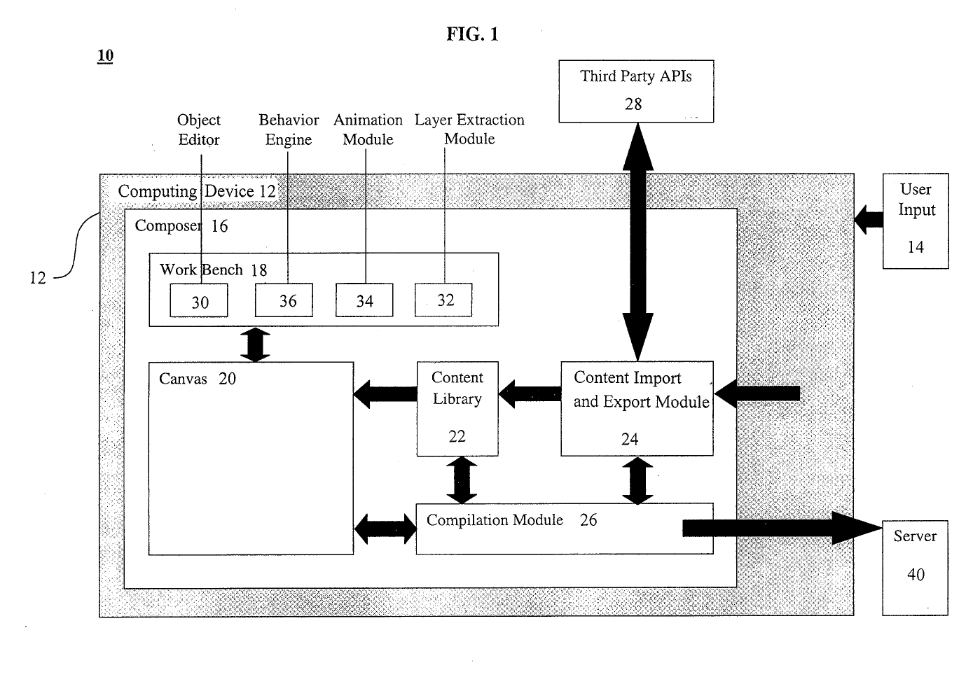

Referring now to FIG. 1, one embodiment of a system of the present disclosure is illustrated. The system 10 may include, a computing device 12 with a multi-touch user input and display interface 14, one or more processors (not shown) operably connected to one or more computer readable storage devices, such as a hard drive, flash memory drive, or random access memory. The computing device 12 may also have one or more network interfaces configured to transmit and receive data from a communications network, such as the Internet. In addition to a direct wire connection for the network interface, a wireless network interfaces may be utilized to connect to the communications network, such as, by way of example, a cellular telephone network interface or an interface implementing the IEEE 802.11 family of wireless networking protocols. Examples of the computing device 12 include Apple iOS products such as the iPad™, iPhone™, iPod Touch™; Android multi-touch tablets and smartphones such as the Samsung Galaxy Tab™ or those from Motorola; the Blackberry Playbook™ or other devices that work on other multi-touch operating systems such as Windows 7™ or computers with multi-touch displays.

The computing device 12 is configured to include, or have access to (over the Internet, for example), a composer application 16 that allows a user to import assets or content, and create and edit interactive digital books. The composer 16 includes a work bench 18, a canvas interface 20, a content library 22, a content import and export module 24, and a compilation module 26. The computing device is further configured to receive user input from the multi-touch user input and display interface 14, thereby directing the control of the composer application 16 and its components.

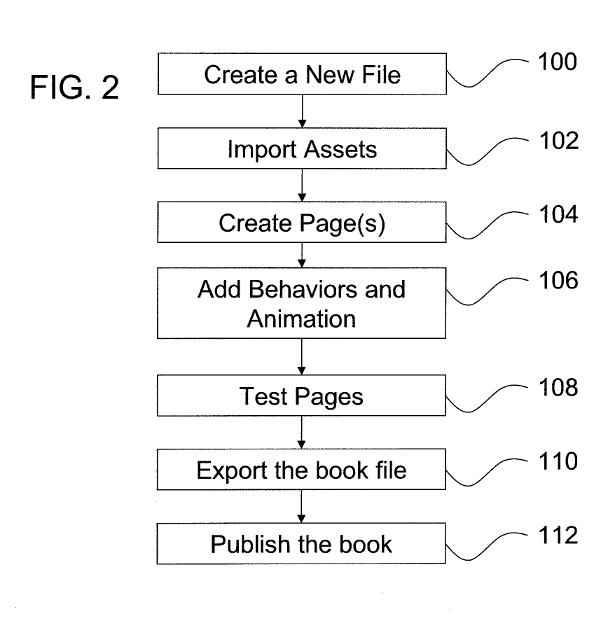

The system 10 allows a user to import content or assets along with triggering events and behaviors, and to create, test, and publish an interactive digital book in a series of steps, as illustrated in FIG. 2. In step 100, the user creates a new interactive book using the composer module 16. When a book is created the composer module 16 creates a new file or allows the user to name and create a new file within the content library 22. The system 10 is also configured to create a new interactive book from an imported file. In this case, the composer module 16 receives the existing interactive book, such as an EPUB file, and converts the file content into a markup language file, such as a DFML file (Demibooks Format Markup Language, from Demibooks, Inc.) The DFML file allows the user to edit the existing file by manipulating the existing content or adding new content. In step 102, a user can import assets or content to be used in the newly created book (file). Assets are imported by the content import and export module 24, which is configured to communicate with third party APIs 28 on the computing device 12 or with a remote server 40 over a communications network using the network interface of the computing device 12. Assets received from a third party API 28 or a server 40 are stored in the content library 22.

An example of a third party API 28 is the iTunes™ library that can be present on the computing device 12, while examples of a server 40 include digital file repositories such as those offered by www.dropbox.com or the Apple iCloud™ service. Examples of assets or content include images, digital photos, text, animation sequences, audio files, and video files. Animation sequences are a series of individual images that are displayed in sequence to create the animation effect. As examples, the animation images can be received as individual image files that the user then associates into the animation sequence, or the animation images can be received as part of a compressed file package containing sequentially numbered images that the content import and export module 24 automatically associates into an animation sequence. Animation sequences can also be imported as an animated GIF file that is converted to a DFML animation object by the content import and export module 24.

Animation sequences can also include image sequences that represent a full rotation of an asset through 360 degrees. These rotational sequences, or spinners, allow the animation to stop and start within the image sequence. When combined with triggers and events as described herein, these stop-and-start animation sequences can be utilized to make an asset appear to “turn” in response to user input received through the multi-touch display input.

The system 10 allows an asset imported by the content import and export module 24 to have multiple versions. The versions of an asset are associated with the same asset name, but have content variations. For example, an audio asset narrating a page could have an English narration, a French narration, and a German narration, where each narration is a stored as a version of a single narration asset. Such versioning greatly simplifies the organization of assets.

The content library 22 can be implemented as a database, for example, an SQLite database, or using a file system within the computing device 10. The content library can be configured to either maintain user books and assets in separate databases, or maintain them in a single database. The content library 22 enables the user to navigate and draw upon assets that have been either imported to or created in the composer module 16. Assets within the content library 22 can be sorted, searched, tagged, and removed by the user. When using the file system of the computing device 10, separate folders for each book can be maintained to organize the imported assets used in each book.

After importing assets 102 in FIG. 2, the user may create the pages 104 of the interactive book by utilizing the available assets. Available assets are accessed from the workbench 18, which utilizes a menu system that allows the user to select both the type of asset to be added, and the individual asset from that group. Once an asset has been selected from the workbench 18, it appears on the canvas 20. Assets can be placed on one page, or can be added to many pages.

The canvas 20 is the fully editable area of the composer module 16 where assets are arranged and manipulated into the pages of the interactive book. The canvas 20 depicts a single page of the interactive book, and can be displayed with a grid to assist the user in the placement of assets within that page.

After creating pages 104, the user may then add behaviors and animations 106. Behavior and animations can be created using the workbench 18, which includes an object editor module 30, a layer extraction module 32, an animation module 34, and a behavior engine module 36. The steps shown in FIG. 2 and described herein are not limited to the order shown in FIG. 2, and the steps can be re-arranged to effect the creation of the interactive book.

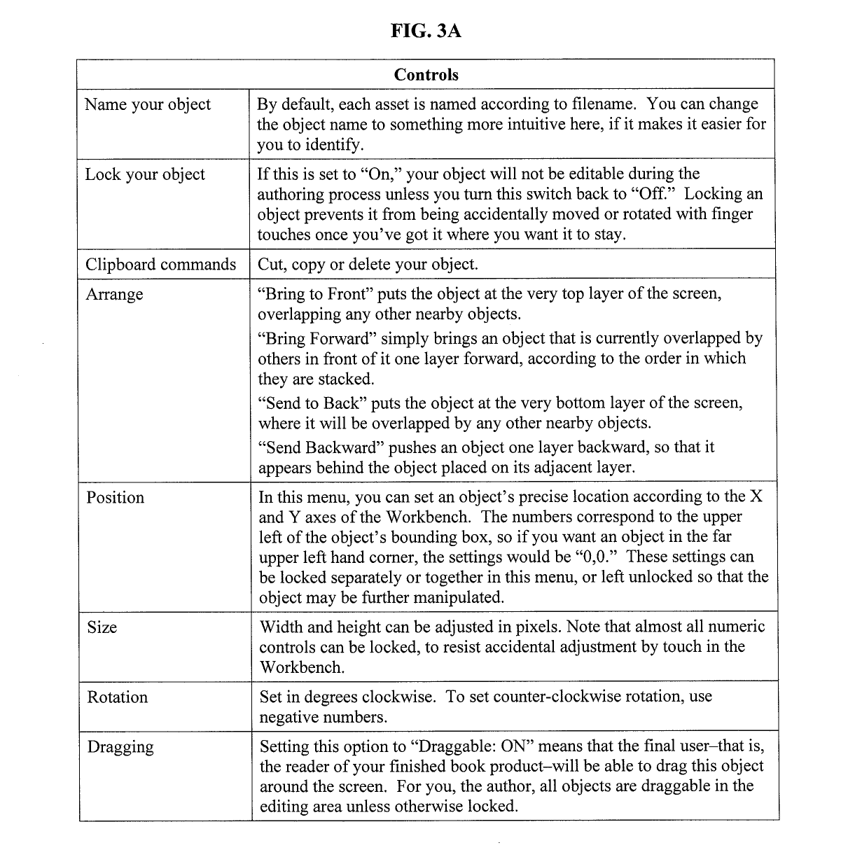

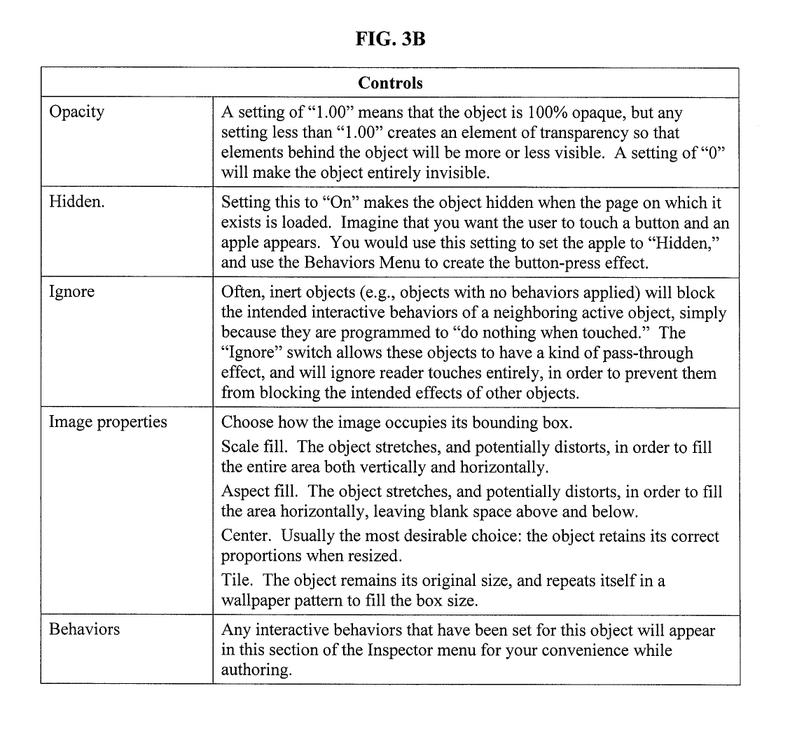

The object editor module 30 enables a user to arrange and manipulate an asset by changing its scale, position, depth, and transparency. Assets presented within the canvas 20 can be manipulated through user inputs from the multi-touch display input, such as dragging assets by swiping a finger, resizing assets by pinching fingers together or apart, or rotating assets by using a rotating finger on the screen. The object editor module 30 further includes a menu interface that allows the user to adjust an asset's properties, such as those listed in FIG. 3, for example.

From the menu interface, the object editor module 30 may allow the user to enable a physics effect for an asset by toggling the physics option to “on.” When the physics effect is enabled, assets are allowed to move within the page and respond to user input on the multi-touch display, such as being flung or shoved by a user's finger gesture. Assets with physics effect enabled can also bounce off of or stick to other objects, be designated to automatically avoid collisions, or experience a mimicked gravity effect within the page. In addition to enabling the physics effects, generally, the user may enable a subset of the effects, such as only gravity or the property of automatically avoiding collisions.

The layer extraction module 32 allows the user to manipulate assets by separating the visual elements into multiple layers. This allows the user to animate only selected elements from a larger visual asset.

Before a visual element of an asset can be separated into a distinct layer, the contours of that element must first be defined. The user accomplishes this through plotting the bounds of the visual element to be extracted using a series of specialized gestures. Each execution of a specialized gesture plots a region vertex on the multi-touch input display device, and collectively the plots are known as region vertices. The region vertices and the image data can be processed by the computing device 12 using a context-sensitive fill algorithm to separate the visual elements into separate layers that are saved as separate assets. Alternatively, the (X, Y) position of all region vertices, along with the image data located within the region, can be sent to a server 40 for processing with the context-sensitive fill algorithm. The server 40 then returns the separate layers to the canvas 20 and which are deposited within the content library 22 as separate assets. A similar approach can be employed to extract text from an image asset, with the chief difference being that instead of applying a context-sensitive fill algorithm, the server would apply an optical character recognition (OCR) algorithm.

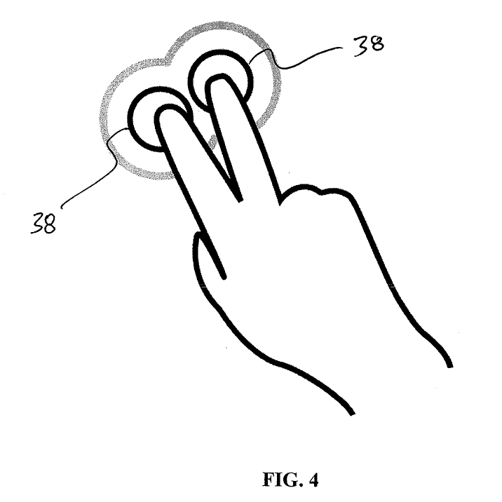

The animation module 34 is configured to allow the user to create animation effects for page assets. The animation module 34 operates by translating the user's finger touch gestures into animation effects. As an example shown in FIG. 4, a gesture begins when a user touches two fingers to the multi-touch input device 14. The points of contact between the user's fingers and the input device 14 can be referred to as the touch points 38. The gesture concludes when the user lifts one or more fingers from the input device 14. It should be noted that the fingers need not be constituents of the same hand.

To initiate an animation effect using a gesture, the user first activates a button (not shown) on the workbench 18. Once a gesture is initiated, the user input from the multi-touch display 14 is analyzed by the animation module 34 to determine the absolute and relative positions of the touch points 38 throughout the gesture. The changes in absolute and relative positions of the touch points 38 are used by the animation module 34 to calculate representative vectors of the respective changes. These vectors are then associated with assets and used during animation playback. Recording ends when all touch points end, which occurs when the user lifts the fingers from the input device.

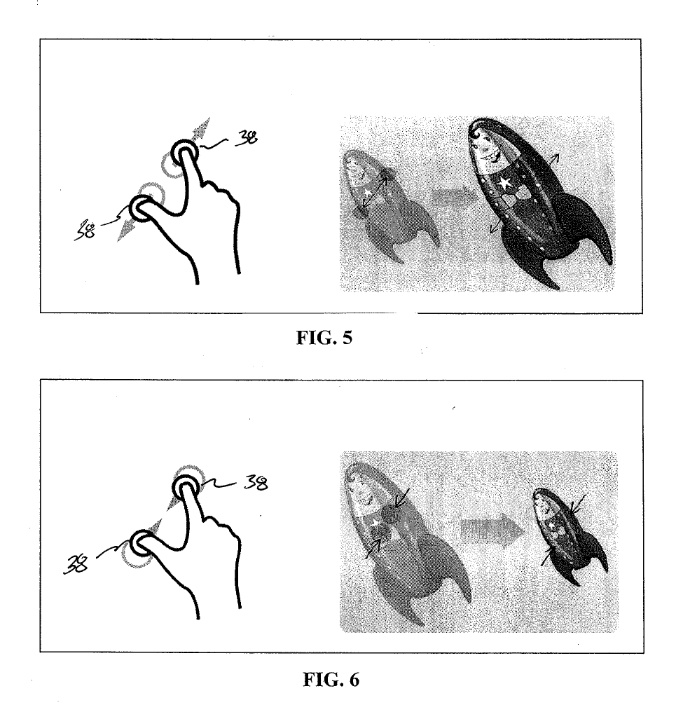

If the distance between two touch points changes over time, then the animation module 34 calculates the difference in distance between touch points 38, and uses this difference as a coefficient in resizing the scale of the object associated with the gesture. The resulting effect is that the object shrinks or grows. This effect is called a “Pinch In” or “Pinch Out” depending on whether the distance between touch points increases or decreases, as shown in FIGS. 5 and 6, respectively.

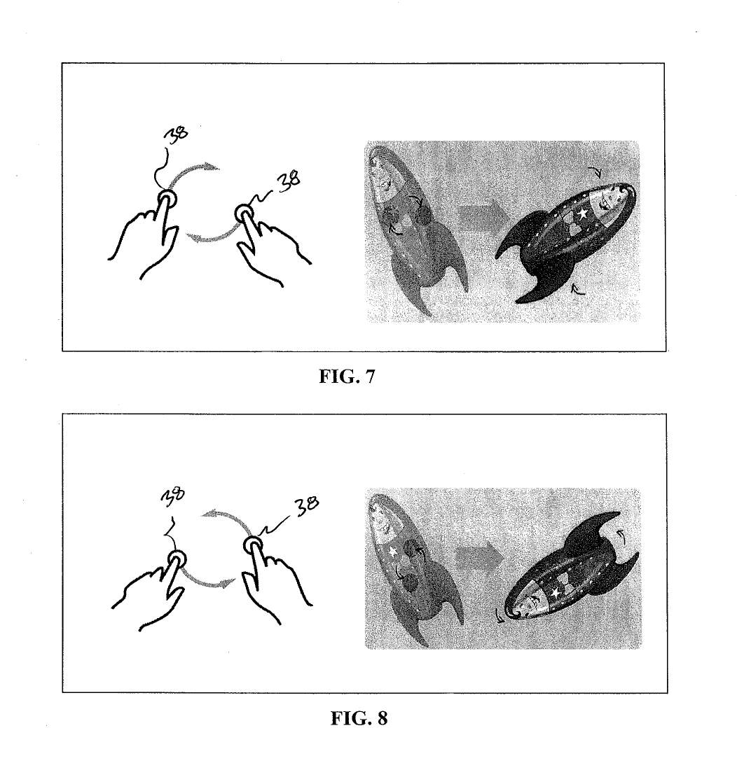

If the touch points 38 are rotated about a central axis, then the animation module 34 calculates the degrees and direction of rotation, and uses this as a basis for rotating the asset associated with the gesture. The resulting effect is that the asset pivots around a central point. This is called a “Rotate Clockwise” or “Rotate Anti-Clockwise” effect, as shown in FIGS. 7 and 8, respectively.

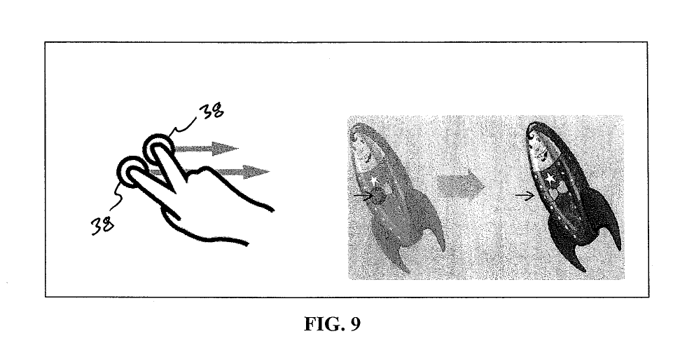

If both the touch points 38 are moved along the input device, then the animation module 34 monitors their path of motion, and applies an equivalent path to the asset associated with the gesture. The resulting effect is that the asset moves similarly along the page. This effect is called a “Drag” and is illustrated in FIG. 9.

The Pinch In/Out, Rotate, and Drag effects can be combined into a single gesture to produce more than one animation effect. For example, if the user executes a gesture in which he moves his entire hand along the input device while simultaneously moving his fingers apart, the single gesture will cause both a Drag effect and a Pinch Out effect. The animation module 34 also utilizes the velocity of a gesture when applying effects. When the user drags his fingers across the input device quickly, the animation module 34 will generate a faster animation effect than a gesture in which the user drags his fingers slowly. There are many different ways that this functionality can be accomplished and the gestures described herein are only exemplary.

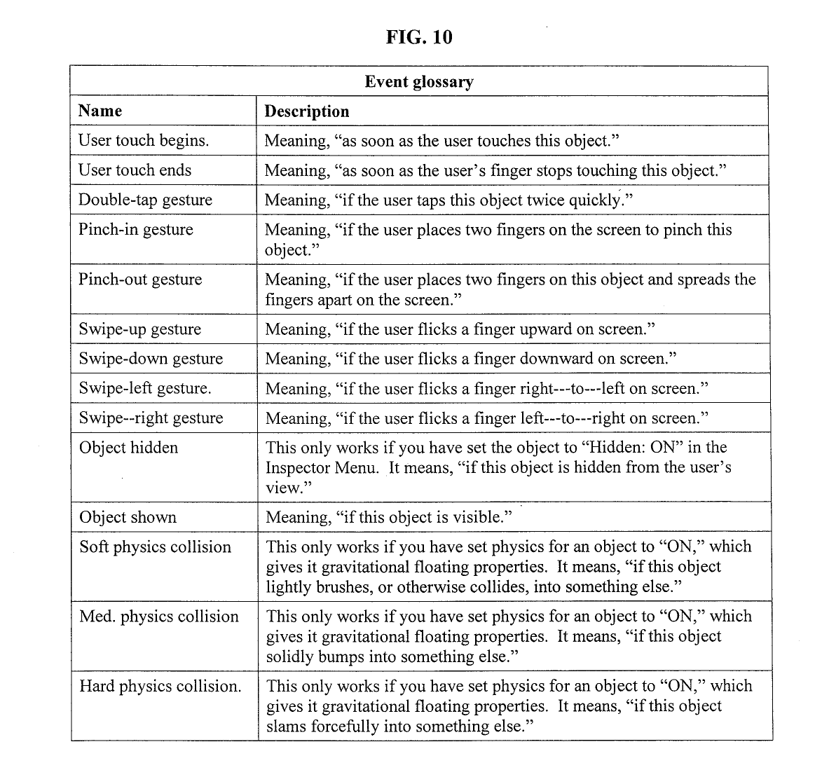

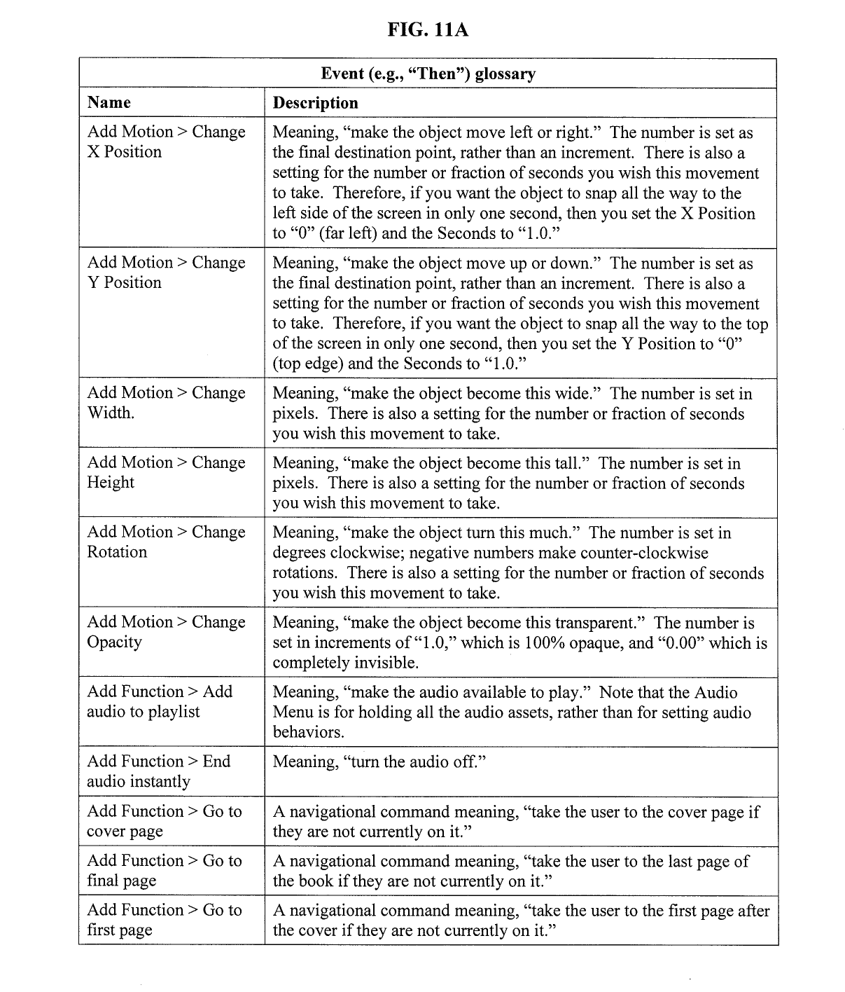

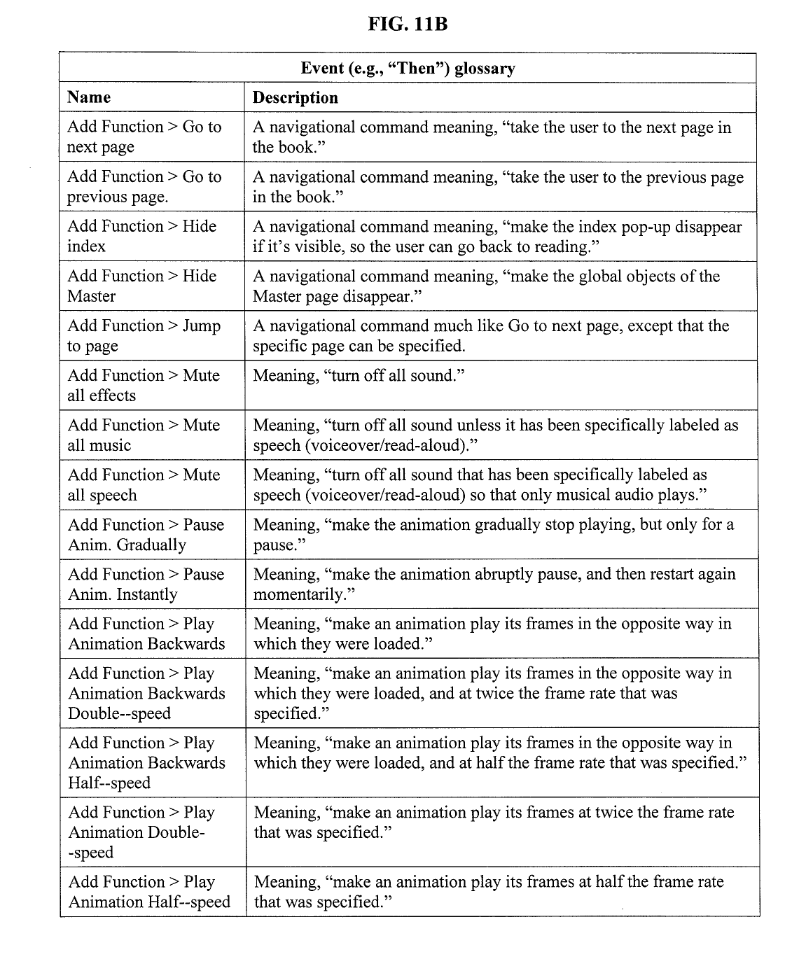

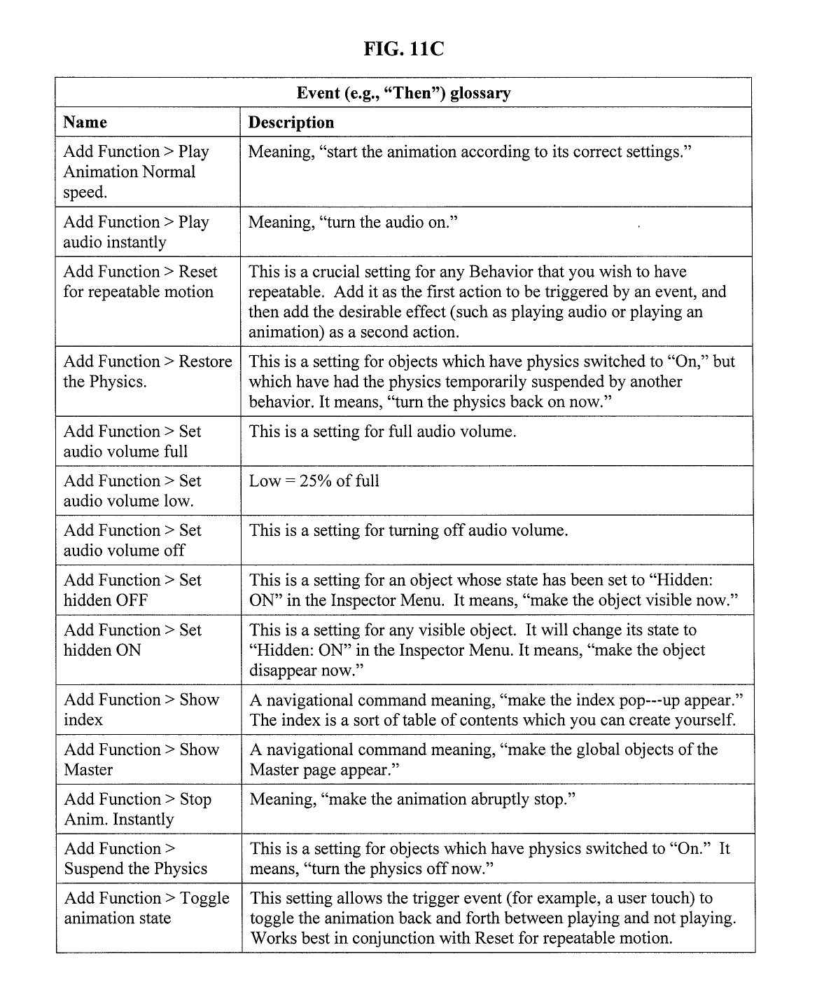

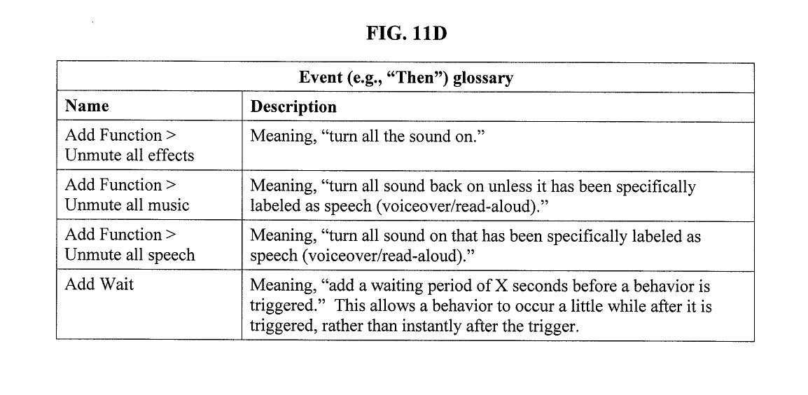

The composer 16 allows the user to quickly create predefined animation effects for an asset using the behavior engine module 36. The behavior engine module 36 is configured to allow the user to link interactive events to one or more triggers based on multi-touch display input from the reader. The behavior engine module 36 allows the user to create such links using the multi-touch display, rather than coding the actions. For example, once a user has recorded an animation through the animation module 34, and wishes to make the animation available to the reader of his digital book, he must create a trigger that would enable the reader to activate the animation. Examples of available triggers and events are listed in the tables in FIGS. 10 and 11, respectively.

One type of behavior that can be applied to an object is an animation ease. The animation ease allows an object to move in a life-like manner, such as bouncing or elastic stretching, by applying a predefined effect to an object. For a bounce, the animation ease can move the asset image through a series predetermined arcs within the page. This causes the object to animate through a bouncing sequence. The animation ease behaviors do not require the user to specifically generate an animation effect, and therefore can streamline page production for commonly used animations. The behavior engine module 36 can also be used to link events like page turns, to functions like playing a media asset (e.g. audio narration). Other examples of the types of effects that are possible to implement using behaviors include navigation within the book, by jumping to a new page or returning to a previous page, manipulating animation sequences by jumping to specific animation frames, manipulating videos by playing, pausing, or stopping, and incorporating external content by linking to web URLs that are launched in a web browser present in the computing device.

The behavior engine module 36 allows the user to streamline the behavior assignment process by allowing the behaviors assigned to one asset to be copied to other objects. The user first selects the asset having the behavior to be copied, then indicates that the behaviors are to be copied using a button displayed in the workbench 18, and finally the user selects the asset to which the behavior is to be applied.

Referring now to FIG. 2, after behaviors and animations have been assigned in step 106, the interactive book can be tested, as in step 108. When testing, composer 16 exports the interactive digital book as a completed file capable of being viewed with a viewer application, such as a web browser, etc., depending on the exported file type. The composer 16 includes a viewer layer configured to display the interactive digital book as the reader would receive it on their own computing device. This allows the author to test the asset layout, including previewing the function of each trigger and behavior. The author can exit the viewer layer to make revisions within the composer 16, thereby refining and revising the interactive book.

After the testing in step 108, the interactive book can be exported, as in step 110, using the compilation module 26. The compilation module 26 is configured to combine assets from the content library 22 with the outputs of the object editor module 30, layer extraction module 32, animation module 34 and behavior engine module 36, and package it into a format that is suitable to be exported to a viewer application. The non-image outputs of the compilation module 26 can be expressed in an XML-based language, such as DFML, created by Demibooks, Inc. The compilation module 26 can also send its output to the canvas 20 where the generated DFML and the media elements of the content library 22 are interpreted by a viewer layer to render a version of the interactive book for testing and editing. In addition to exporting the completed file in a DFML format, the compilation module can export the completed file in formats suitable for viewing by third party applications. Examples of alternative file formats include EPUB3, HTML 5, CSS, and Javascript.

The compilation module 26 can use the network interface of the computing device 12 to communicate the exported file to third party servers 40 (shown in FIG. 1), such as a web host or online cloud server, over a communications network such as the Internet. This allows the exported file to be quickly communicated to centralized distribution channels for third party viewers.

Each DFML entity describes a single book, page, layer, asset, behavior or media item created or edited in the composer 16. These entities may all be present in a single master document file, or spread between any number of document files and indexed by a manifest entity for the fast lookup. After the completed file has been exported as in step 110, the interactive book can be published 112. When a digital book is published, the collection of DFML documents and media elements (images, audio, video) generated by composer 16 are packaged together with the application code of the viewer layer to create an application that can interpret and render the book, play back its media elements, handle user interactions and so forth from the completed file. Thus, publication combines the content of a completed file with application code, allowing the interactive book to be a stand-alone application. The compilation module 26 can publish the interactive book by exporting the completed file to a server 40, which packages the completed file with the application program layer. The server 40 can further transmit the published interactive book to digital distributors, such as the App Store maintained by Apple, Inc., to be purchased by the intended reader.

Although various embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention or aspect of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A digital interactive book generating system for allowing a user to import and create animated content into an interactive digital book on a computing device having a touch screen input and display, comprising:
a microprocessor, a memory and computer software, said computer software being located in said memory and configured to be operated by said microprocessor, said computer software comprising an interactive digital book algorithm, wherein said interactive digital book algorithm allows a user to
create a book file,
import and create content,
add text, animation, triggering events and behaviors,
testing the triggering events and behaviors of the digital interactive book, and
exporting a completed file;
a touch screen input device and display, said input device and display configured to allow a user to utilize the interactive digital book algorithm to generate a digital interactive book, such that a reader of said book will observe the animated content based on the triggering events.

2. The digital interactive book generating system of claim 1, in which the interactive digital book algorithm, comprises an object editor module, a layer extraction module, an animation module, and a behavior engine module.

3. The digital interactive book generating system of claim 2, in which the object editor module enables the user to arrange and manipulate said content by changing the scale, position, depth or transparency of said content.

4. The digital interactive book generating system of claim 3, in which said manipulation of said content is accomplished by swiping a finger across said touch screen input and display device, such as dragging content with a finger, resizing content with a pinching finger input, or rotating content using a circular motion on the screen.

5. The digital interactive book generating system of claim 2, in which the layer extraction module enables the user to manipulate content by separating the visual elements of said content into multiple layers, thereby allowing the animation of only selected elements from a larger content.

6. The digital interactive book generating system of claim 2, in which the animation module enables the user to create animation effects for said content by translating a user's finger touch gesture into animation effects.

7. The digital interactive book generating system of claim 2, in which the behavior engine module enables the user to link interactive behavior effects to one or more triggers based on an input from a reader on said touch screen input and display device rather than programming the actions in a programming language.

8. The digital interactive book generating system of claim 10, in which said triggers comprise one or more of the following: a screen touch, a screen touch end, double tapping the screen, a pinch-in gesture, a pinch-out gesture, a swipe up gesture, a swipe-down gesture, a swipe-right gesture and a swipe-left gesture.

9. The digital interactive book generating system of claim 7, in which said behaviors comprise one or more of the following: making the object move left or right, making the object move up or down, making the object become wider or taller, making the object rotate, making the object change opacity, changing the volume, changing the navigation of the pages, changing the speed or direction of the animation, changing the physics of the object in motion.

10. The digital interactive book generating system of claim 1, wherein said content comprises one or more of an image file, a picture file, a text file, a video file, an audio file, or an animation file.

11. The digital interactive book generating system of claim 2, wherein said object module is configured to enable the user to activate one or more physics effects for content.

12. A method for allowing the creation of content for a digital book on a computing device and for allowing the addition of animation effects to render the content of said digital book interactive, comprising a microprocessor, an touch screen input device, a display, a memory and computer software, said computer software being located in said memory and run by said microprocessor, said computer software comprising an interactive digital book algorithm, wherein said interactive digital book algorithm comprises the steps of:
(a) providing a book file representing an interactive digital book;
(b) allowing for the importation of content;
(c) creating a page based on the imported content;
(d) allowing for the navigation of the content on said page;
(e) allowing for the addition of animations to said content on said page;
(f) allowing for the addition of triggers and behaviors to said content on said page;
(g) if necessary, returning to step (c) for additional pages;
(h) previewing said assets on said page; and
(i) allowing for the editing of said assets on said page.

13. The method for allowing the creation of content for a digital book on a computing device of claim 12, in which the interactive digital book algorithm, comprises an object editor module, a layer extraction module, an animation module, and a behavior engine module.

14. The method for allowing the creation of content for a digital book on a computing device of claim 13, in which the object editor module enables the user to arrange and manipulate said content by changing the scale, position, depth or transparency of said content.

15. The method for allowing the creation of content for a digital book on a computing device of claim 14, in which said manipulation of said content is accomplished by swiping a finger across said touch screen input and display device, such as dragging content with a finger, resizing content with a pinching finger input, or rotating content using a circular motion on the screen.

16. The method for allowing the creation of content for a digital book on a computing device of claim 13, in which the layer extraction module enables the user to manipulate content by separating the visual elements of said content into multiple layers, thereby allowing the animation of only selected elements from a larger content.

17. The method for allowing the creation of content for a digital book on a computing device of claim 13, in which the animation module enables the user to create animation effects for said content by translating a user's finger touch gesture into animation effects.

18. The method for allowing the creation of content for a digital book on a computing device of claim 13, in which the behavior engine module enables the user to link interactive behavior effects to one or more triggers based on an input from a reader on said touch screen input and display device rather than programming the actions in a programming language.

19. The method for allowing the creation of content for a digital book on a computing device of claim 18, in which said triggers comprise one or more of the following: a screen touch, a screen touch end, double tapping the screen, a pinch-in gesture, a pinch-out gesture, a swipe up gesture, a swipe-down gesture, a swipe-right gesture and a swipe-left gesture.

20. The method for allowing the creation of content for a digital book on a computing device of claim 18, in which said behaviors comprise one or more of the following: making the object move left or right, making the object move up or down, making the object become wider or taller, making the object rotate, making the object change opacity, changing the volume, changing the navigation of the pages, changing the speed or direction of the animation, changing the physics of the object in motion.

21. The method for allowing the creation of content for a digital book on a computing device of claim 12, wherein said content comprises one or more of an image file, a picture file, a text file, a video file, an audio file, or an animation file.

22. The method for allowing the creation of content for a digital book on a computing device of claim 13, wherein said object editor module is configured to enable the user to activate one or more physics effects for content.
